(19) United States
(12) Patent Application Publication
(10) Pub. No.: US 2016/0269102 A1
(43) Pub. Date: Sep. 15, 2016

(54) APPARATUS FOR TRANSMITTING AND RECEIVING DATA USING NETWORK CODING IN MULTIPLE TRANSMISSION PATHS

(71) Applicant: Electronics and Telecommunications Research Institute, Daejeon (KR)

(72) Inventor: Man Kyu PARK, Daejeon (KR)

(21) Appl. No.: 15/066,028

(22) Filed: Mar. 10, 2016

(30) Foreign Application Priority Data
Mar. 10, 2015 (KR) 10-2015-0032983

(51) Int. Cl. H04B 7/185; H04L 12/707; H04L 1/00

(52) U.S. Cl. CPC H04B 7/18586; H04B 7/18593; H04L 1/0045; H04L 1/0076; H04L 45/24

(57) ABSTRACT

An apparatus for transmitting and receiving data in multiple transmission paths including a satellite network path and a wired network path, the apparatus that receives content data through a satellite network path, receives redundant data including information to be used to restore the content data through a wired network path, and restores a lost portion of the content data using the redundant data, the redundant data being generated by applying network coding to the content data, is provided.

### CROSS-REFERENCE TO RELATED APPLICATION

This application claims the priority benefit of Korean Patent Application No. 10-2015-0032983, filed on Mar. 10, 2015, in the Korean Intellectual Property Office, the disclosure of which is incorporated herein by reference.

### BACKGROUND

1. Field of the Invention

Embodiments relate to an apparatus for transmitting and receiving data through a satellite network, and more particularly, to an apparatus for transmitting and receiving data in multiple transmission paths including a satellite network and a wired network.

2. Description of the Related Art

Satellite communication refers to communication using a geostationary satellite positioned outside the atmosphere and revolving around the earth at a speed equal to a rotation speed of the earth. Satellite communication uses microwaves, and thus may perform high-speed and high-capacity communication and provide coverage to a wide area, for example, the entire area of a predetermined country. Further, satellite communication may provide stable communication irrespective of geographical features and be free from communication restraints even when disaster occurs. However, in satellite communication, a radio wave may require a round trip time of about 0.24 seconds. Thus, the radio wave may be delayed during audio communication, and security of data may not be guaranteed. In addition, since solar cells are used as a power source, data loss, for example, temporary communication loss, may occur when a satellite is in the shade of the earth or when it rains heavily.

### SUMMARY

According to an aspect, there is provided a data receiving apparatus including a first interface configured to receive content data transmitted through a satellite network path, a second interface configured to receive redundant data transmitted through a wired network path, the redundant data including information to be used to restore the content data, and a processor configured to restore a lost portion of the content data using the redundant data. The redundant data may be generated by applying random linear network coding to the content data.

The first interface may be configured to receive the content data in real time, and the second interface may be configured to receive the redundant data before the content data is received through the first interface. The first interface may be configured to receive the content data from a content data provider by performing satellite communication using a predetermined satellite bandwidth, and the second interface may be configured to receive redundant data with respect to the content data from the content data provider by performing terrestrial communication using a predetermined wired bandwidth.

According to another aspect, there is also provided a data receiving apparatus including a first interface configured to receive content data transmitted through a first communication network path, a second interface configured to receive redundant data including information to used to restore the content data through a second communication network path differing from the first communication network path, and a processor configured to restore a lost portion of the content data using the redundant data. The first communication network path and the second communication network path may be two different network paths selected from a satellite network path, a terrestrial wireless network path, and a wired network path. The redundant data may be generated by applying random linear network coding to the content data.

According to still another aspect, there is also provided a data receiving apparatus including a first interface configured to receive general data transmitted through a satellite network path, among original data including security data and the general data, a second interface configured to receive the security data through a wired network path, and a processor configured to regenerate the original data by combining the security data and the general data. The original data may be divided into the general data and the security data by a preset criterion. The second interface may be configured to receive security data to which a preset encryption method is applied, and the processor may be configured to restore the original data by applying a decryption method corresponding to the encryption method to the security data.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a data receiving apparatus according to an embodiment;

FIG. 2 is a diagram illustrating a process of receiving content data and redundant data in data receiving apparatuses according to an embodiment;

FIG. 3 is a diagram illustrating a process of transmitting and receiving content data through multiple transmission paths according to an embodiment;

FIG. 4 is a diagram illustrating a process of receiving redundant data by applying network coding according to an embodiment;

FIG. 5 is a diagram illustrating a process of restoring lost data by applying random linear network coding according to an embodiment;

FIG. 6 is a block diagram illustrating a data receiving apparatus according to an embodiment; and

FIG. 7 is a block diagram illustrating a data transmitting apparatus according to an embodiment.

### DETAILED DESCRIPTION

Hereinafter, reference will now be made in detail to embodiments with reference to the accompanying drawings, wherein like reference numerals refer to like elements throughout. However, the scope of the disclosure is not limited by those embodiments.

The terms used herein are mainly selected from general terms currently being used in related art(s). However, other terms may be used depending on development and/or changes in technology, custom, or a preference of an operator. Thus, it should be understood that the terms used herein are terms merely used to describe the embodiments, rather terms intended to limit the spirit and scope of this disclosure.

In addition, in a specific case, most appropriate terms have been arbitrarily selected by the inventors for ease of description and/or for ease of understanding. In this instance, the meanings of the arbitrarily used terms will be clearly explained in the corresponding description. Hence, the terms should be understood not by the simple names of the terms, but by the meanings of the terms and the following overall description of this specification.

Data may be transmitted and received using radio waves through a wireless communication network or wireless network which uses a base station installed on the ground, a wired communication network which uses a cable connecting a provider directly to a consumer, or a satellite communication network which uses a satellite outside the atmosphere. The wired communication network may be used to transmit and receive a large volume of data such as application data and non-real-time broadcast content, for example, content provided through an Internet protocol television (IPTV). The wireless communication network may be used to transmit and receive audio data, for example, of a phone call, image data, and text data in a mobile communication terminal such as a portable phone. The satellite communication network may perform high-speed and high-capacity communication and provide coverage to a wide area when compared to other communication networks. Thus, the satellite communication network is widely used in broadcast communication fields recently. For example, real-time broadcast content and related control signals for broadcast may be transmitted through the satellite network. To transmit and receive predetermined data, a communication device may be determined based on features of each communication network. In this example, a terminal capable of receiving data through the single determined communication network may be used.

Meanwhile, a single data receiver may receive data through various transmission paths. The data receiver may include equipment configured to receive data transmitted through at least one communication network. For example, a device supporting both wireless communication and wired communication may receive audio data transmitted through wireless communication, and also receive IPTV content transmitted through wired communication.

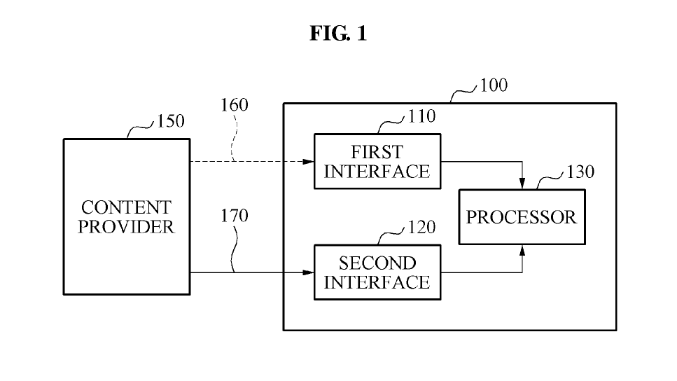

FIG. 1 is a block diagram illustrating a data receiving apparatus 100 according to an embodiment. The data receiving apparatus 100 may include a first interface 110 and a second interface 120 configured to receive data from a content provider 150, and a processor 130 configured to process the received data. The data receiving apparatus 100 may include the first interface 110 and the second interface 120 respectively connectable to communication networks to receive data transmitted through one or more different paths. For example, as shown in FIG. 1, the data receiving apparatus 100 may include the first interface 110 connectable to a satellite communication network 160, and the second interface 120 connectable to a wired communication network 170.

The first interface 110 may receive content data transmitted through the satellite communication network 160. In this example, the first interface 110 may receive the content data in real time. Receiving the content data in real time refers to receiving the content data immediately when the content data is transmitted by the content provider 150, and may include, for example, receiving broadcast content in a broadcast time.

The second interface 120 may receive data transmitted through the wired communication network 170. The data received through the second interface 120 may be associated with the content data received through the first interface 110. In detail, the data received through the second interface 120 may be redundant data including information to be used to restore the content data. As will be described below, when a portion of the content data received through the first interface 110 is lost, the processor 130 may restore the lost data using the redundant data received through the second interface 120. The second interface 120 may receive the redundant data before the content data is received through the first interface 110. When the content data is received in real time through the first interface 110, the second interface 120 may receive the redundant data with respect to the corresponding content data in advance. For example, when broadcast content is to be received as content data through the first interface 110 based on a broadcast schedule, redundant data with respect to the corresponding broadcast content may be received through the second interface 120 before a broadcast time.

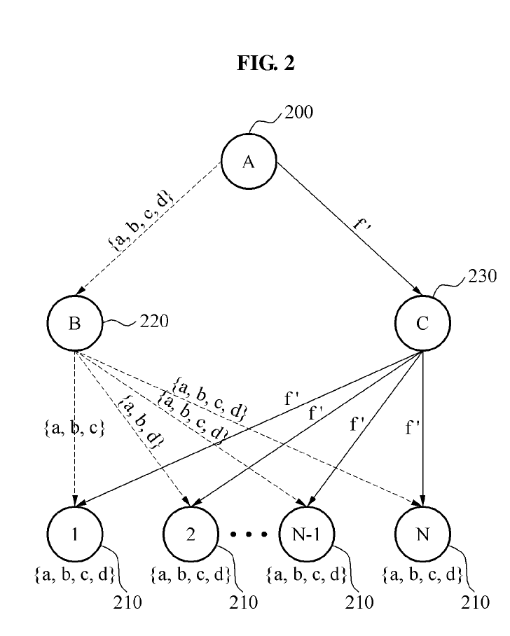

FIG. 2 is a diagram illustrating a process of receiving content data and redundant data in data receiving apparatuses 210 according to an embodiment to describe the data receiving apparatus 100 of FIG. 1 in detail. Referring to FIG. 2, a content provider A 200 such as a broadcaster server may transmit content data {a, b, c, d} to the data receiving apparatuses 210. The N data receiving apparatuses 210 may be implemented as terminals having multiple interfaces connectable to a satellite communication network indicated with broken lines and a wired communication network indicated with solid lines. Data may be transmitted through two network paths, in detail, the satellite network indicated with broken lines and including a satellite central station system B 220, and the wired network indicated with solid lines and including terrestrial wired network data transmission equipment C 230. The content provider A 200 may transmit the content data {a, b, c, d} through the satellite network path, and transmit redundant data with respect to the content data, in detail, redundant data {f} including information to be used to restore the content data, through the wired network path. In this example, the redundant data may be generated by applying network coding to the content data. The data receiving apparatuses 210 may receive the content data {a, b, c, d} through the satellite network path, and receive the redundant data {f′} through the wired network path. Among the data receiving apparatuses 210 receiving the content data {a, b, c, d} through the satellite network path, an (N−1)-th data receiving apparatus and an N-th data receiving apparatus may receive all the content data {a, b, c, d}, a first data receiving apparatus may receive a portion {a, b, c} of the content data, and a second data receiving apparatus may receive a portion {a, b, d} of the content data. It may be learned that a loss of data, for example, d or c, has occurred on the satellite network. The data receiving apparatuses 210 may restore the lost data using the redundant data {f′} through a processor. Thus, all of the data receiving apparatuses 210 may obtain the content data {a, b, c, d} ultimately.

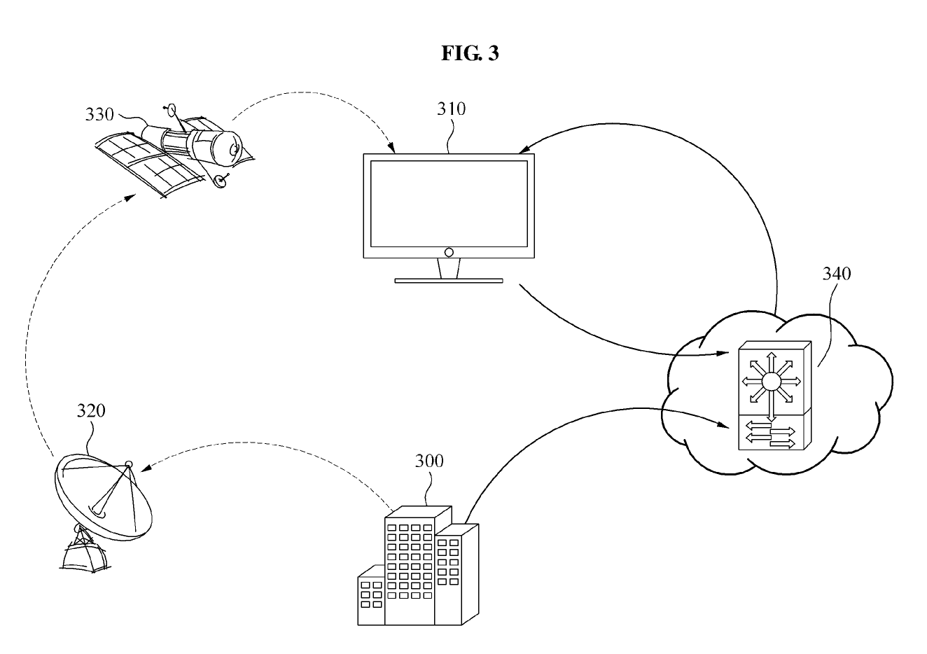

FIG. 3 is a diagram illustrating a process of transmitting and receiving content data through multiple transmission paths according to an embodiment. Referring to FIG. 3, a content provider 300 may transmit content data to a content consumer 310 through a satellite network path indicated with broken lines. In detail, when the content provider 300 transmits the content data to a satellite transmission device 320, the satellite transmission device 320 may transfer the content data to the content consumer 310 through a geostationary satellite 330. Simultaneously, the content provider 300 may provide the content data to the content consumer 310 through a wired network path indicated with solid lines. In detail, the content provider 300 may transmit the content data to the content consumer 310 through a wired network relay 340. As described above, data may be received through multiple communication paths, and thus a probability of identical errors or data loss occurring in a data receiving apparatus may decrease. Data may be lost on the satellite network path due to the weather, whereas the wired network path may not be affected by the weather. Thus, identical data loss may not occur. Further, data may be lost on the wired network path due to damage to cables. However, the satellite network may operate irrespective of damage to the cables, and thus data loss may not occur simultaneously.

Referring to FIG. 1 again, the processor 130 may restore a lost portion of the content data using the redundant data. In general, a probability of data being lost through the satellite network is relatively great. Accordingly, a countermeasure against data loss is needed. In an example, the redundant data to be used to restore the content data received over the satellite network may be additionally received through the second interface 120. The processor 130 may perform a data restoring process with respect to the lost data using the redundant data, thereby assuring completion of data reception.

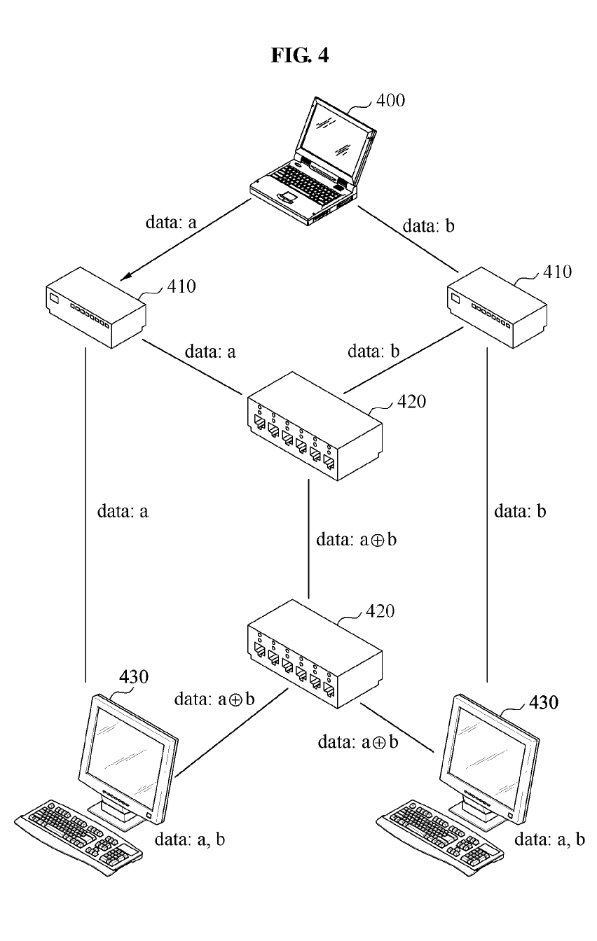

The redundant data may be received through the wired network, and network coding may be applied to the redundant data. FIG. 4 is a diagram illustrating a process of receiving redundant data by applying network coding according to an embodiment. Network coding is a method of transmitting a greater amount of data during a unit time by coding a data transmission process using a relay acting as an intermediate node of data transmission and reception when a server transmits data to a user. Referring to FIG. 4, a server 400 may transmit data a and data b to a first user terminal 430 and a second user terminal 430 during a unit time. The first user terminal 430 may receive the data a and data a⊕b from a relay A 410 and a relay D 420. The second user terminal 430 may receive the data b and data a⊕b from a relay B 410 and the relay D 420. In this example, the first user terminal 430 may perform XOR operation with respect to the data a and the data a⊕b received via the two links, thereby obtaining both the data a and the data b. The second user terminal 430 may also perform XOR operation with respect to the data b and the data a⊕b received via the two links, thereby obtaining both the data a and the data b. Since the server 400, the first user terminal 430, and the second user terminal 430 may transmit and receive the two items of data during the unit time, a transmission efficiency in the provided network may be “2”. In a case in which a single item of data is transmitted and received during a unit time, the transmission efficiency may be “1”. In an example, the redundant data generated by applying network coding and transmitted through the wired network path may be received. Since data may be transmitted and received during the unit time at the doubled transmission efficiency, the second interface 120 may sufficiently receive the redundant data while the content data is received through the first interface 110.

The redundant data may be generated by applying random linear network coding to the content data. Random linear network coding is a method that restores an original signal, for example, data to which network coding is yet to be applied, using coded packets, for example, data, received from a destination node with a probability of nearly “1”. Thus, the content data which is the original data may be restored through the redundant data.

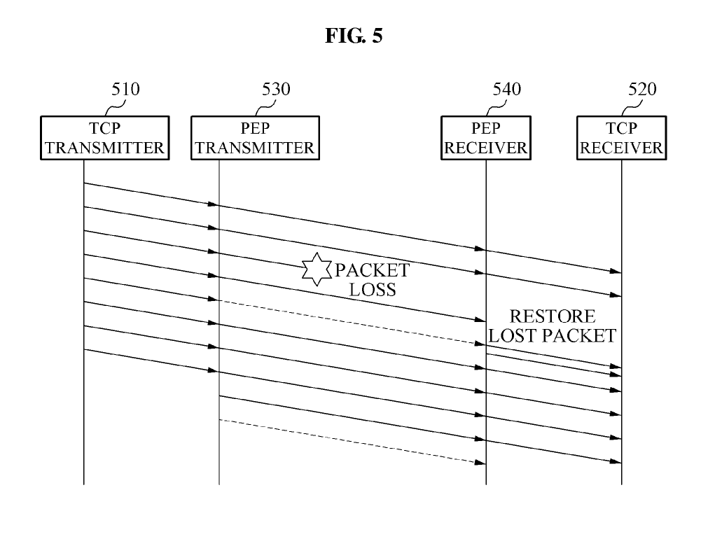

FIG. 5 is a diagram illustrating a process of restoring lost data by applying random linear network coding according to an embodiment. In detail, a transmission control protocol (TCP) transmitter 510 and a TCP receiver 520 may transmit and receive data. Performance enhanced proxy (PEP) equipment may apply random linear network coding to increase TCP performance In FIG. 5, solid lines indicate packet transmission, and broken lines indicate redundant packet transmission. When the TCP transmitter 510 transmits original TCP data, a PEP transmitter 530 may perform network coding with respect to the original TCP data, and transmit the original TCP data and redundant packets generated through the network coding to a PEP receiver 540. Although a portion of the TCP data is lost while transmitted through a satellite network with a high packet loss rate, the PEP receiver 540 may restore the lost packets using the redundant packets, and transmit the lossless TCP data to the TCP receiver 520.

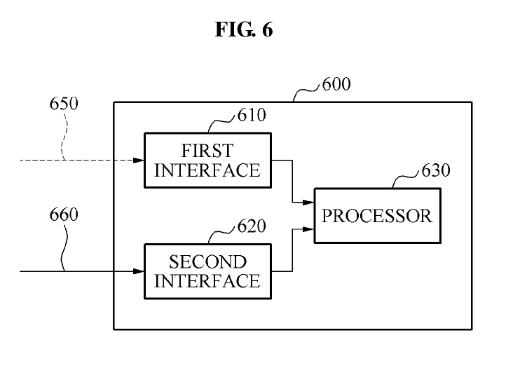

FIG. 6 is a block diagram illustrating a data receiving apparatus 600 according to an embodiment. The data receiving apparatus 600 may receive original data and redundant data through heterogeneous communication networks. Referring to FIG. 6, the data receiving apparatus 600 may include a first interface 610, a second interface 620, and a processor 630. In detail, the first interface 610 may receive content data transmitted through a first communication network path 650. The second interface 620 may receive redundant data including information to be used to restore the content data through a second communication network path 660 differing from the first communication network path 650. The first communication network path 650 and the second communication network path 660 may be two different network paths selected from a satellite network path, a terrestrial wireless network path, and a wired network path. In detail, two different communication network paths may be selected from the satellite network path, the terrestrial wireless network path, and the wired network path to receive data through the first interface 610 and the second interface 620, respectively. Since only two different network paths need to be selected, the first interface 610 may select the wireless communication network path, and the second interface 620 may select the wired communication network path. In this example, the first interface 610 may receive the content data, and the second interface 620 may receive the redundant data with respect to the content data. In detail, the redundant data including the information to be used to restore the content data may be the content data itself. In this example, the data receiving apparatus 600 may receive the same duplicated items of content data through two types of communication networks. In a case in which one item of the content data is lost when receiving the same items of content data, the lost data may be restored based on the other item of content data.

The redundant data including the information to be used to restore the content data may be generated by applying random linear network coding to the content data. Random linear network coding is a method of transmitting data coded using an intermediate node, such as a relay, of a network. Random linear network coding may restore an original signal using data received by a reception node which is a destination. In this example, a probability of restoring the original signal is nearly “1”, and thus a transmission efficiency may increase.

The processor 630 may restore a lost portion of the content data using the redundant data. For example, in a case of the same items of content data are received, or the redundant data generated by applying network coding is received, the original content data may be restored in response to loss of the content data.

In another example, the data receiving apparatus 600 may receive original data being divided through heterogeneous network paths. In detail, general data of the original data may be received using a satellite communication network which enables high-speed and high-capacity transmission, and security data of the original data may be received through a wired communication network which guarantees security since the security data requires security. Accordingly, the data receiving apparatus 600 may include a first interface 610 configured to receive general data transmitted through a satellite network path, among original data including security data and the general data, a second interface 620 configured to receive the security data of the original data through a wired network path, and a processor 630 configured to regenerate the original data by combining the security data and the general data. In this example, the original data may be divided into the general data and the security data by preset criteria. The preset criteria may include personal data of users, medical records of patients, credit information of users, grade information of students, and family information of users. The present criteria may also include ID and password information of users.

The first interface 610 is configured to receive general data, and thus may receive data through a satellite communication network which does not guarantee security. The second interface 620 is configured to receive security data, and thus may receive data through a wired communication network which guarantees security. Meanwhile, the second interface 620 may also receive data through another communication network which provides security, and the first interface 610 configured to receive general data may also receive data through a communication network which guarantees security.

Further, to enhance security, the second interface 620 may receive security data to which a preset encryption method is applied. The second interface 620 may receive security data encrypted using various encryption methods. The encryption methods may include, for example, symmetric-key encryption, public-key encryption, Rivest-Shamir-Adleman (RSA) encryption, and quantum encryption. In this example, the processor 630 may restore the original data by applying a decryption method corresponding to the applied encryption method to the security data.

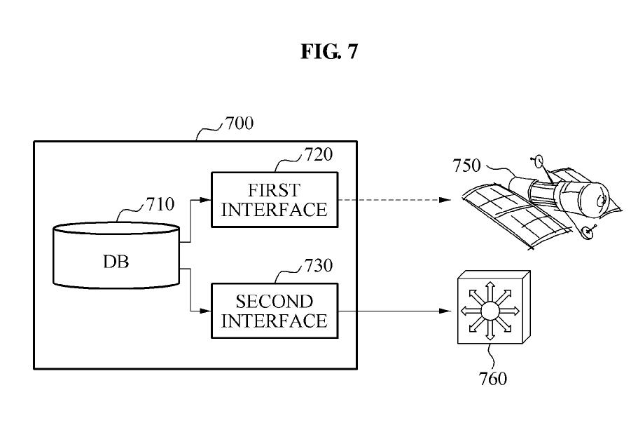

In another example, a data transmitting apparatus may be provided to transmit and receive data through multiple transmission paths. FIG. 7 is a block diagram illustrating a data transmitting apparatus 700 according to an embodiment. Referring to FIG. 7, the data transmitting apparatus 700 may include a database (DB) 710, a first interface 720 and a second interface 730.

The first interface 720 may transmit content data stored in the DB 710 to a geostationary satellite 750 through a satellite network path. A terminal capable of receiving data transmitted through the geostationary satellite 750 over a satellite network may receive the content data.

The second interface 730 may transmit redundant data generated by applying network coding to the content data stored in the DB 710 to a router 760 through a wired network path. The router 760 may transmit the content data to a terminal capable of receiving data transmitted over a wired network.

In this example, the content data may be restored using the redundant data. In detail, the extra redundant data may be transmitted in case of loss of the content data. The redundant data may include information to be used to restore the content data. For example, the redundant data may be the content data itself, or data generated by applying network coding to the content data. In particular, the redundant data may be generated by applying random linear network coding to the content data. Random linear network coding is a communication method that provides high transmission efficiency and restores an original signal using data received from a destination node with a probability of nearly “1”. Thus, the redundant data may be transmitted by applying random linear network coding to the content data.

According to the embodiments provided above, a packet loss rate with respect to a satellite communication network having a high packet loss rate may remarkably decrease. Further, since redundant data generated against data loss may not be transmitted through the satellite communication network, a number of packets to be transmitted through the satellite communication network may not change, and a bandwidth of the satellite communication network may be maintained constant without being reduced. A wired communication network may be additionally used, and thus high-quality image data may be transmitted without loss through the satellite communication path. For example, by applying the foregoing method a satellite broadcast service transmitting high-quality image content in a Ka band highly susceptible to rain attenuation, broadcast content may be transmitted and received effectively.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

As a non-exhaustive illustration only, a terminal or device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A data receiving apparatus comprising:
a first interface configured to receive content data transmitted through a satellite network path;
a second interface configured to receive redundant data transmitted through a wired network path, the redundant data comprising information to be used to restore the content data; and
a processor configured to restore a lost portion of the content data using the redundant data.

2. The apparatus of claim 1, wherein the redundant data is generated by applying random linear network coding to the content data.

3. The apparatus of claim 1, wherein the first interface is configured to receive the content data in real time.

4. The apparatus of claim 1, wherein the second interface is configured to receive the redundant data before the content data is received through the first interface.

5. The apparatus of claim 1, wherein the first interface is configured to receive the content data from a content data provider by performing satellite communication using a predetermined satellite bandwidth.

6. The apparatus of claim 1, wherein the second interface is configured to receive redundant data with respect to the content data through a wireless communication network path.

7. A data receiving apparatus comprising:
a first interface configured to receive content data transmitted through a first communication network path;
a second interface configured to receive redundant data comprising information to used to restore the content data through a second communication network path differing from the first communication network path; and
a processor configured to restore a lost portion of the content data using the redundant data.

8. The apparatus of claim 7, wherein the first communication network path and the second communication network path are two different network paths selected from a satellite network path, a terrestrial wireless network path, and a wired network path.

9. The apparatus of claim 7, wherein the redundant data is generated by applying random linear network coding to the content data.

10. A data receiving apparatus comprising:
a first interface configured to receive general data transmitted through a satellite network path, among original data comprising security data and the general data;
a second interface configured to receive the security data through a wired network path; and
a processor configured to regenerate the original data by combining the security data and the general data.

11. The apparatus of claim 10, wherein the original data is divided into the general data and the security data by a preset criterion.

12. The apparatus of claim 10, wherein the second interface is configured to receive security data to which a preset encryption method is applied, and
the processor is configured to restore the original data by applying a decryption method corresponding to the encryption method to the security data.
